(19) United States
(12) Patent Application Publication
(10) Pub. No.: US 2023/0198016 A1
(43) Pub. Date: Jun. 22, 2023

(54) METHOD OF MAKING AND PROCESSING CATHOLYTE AND ANOLYTE FOR SOLID STATE BATTERIES

(71) Applicant: HYZON MOTORS INC., Honeoye Falls, NY (US)

(72) Inventors: Rajesh Bashyam, Delta (CA); Zhijun Gu, Naperville, IL (US); Sai Nitin Yellamilli, Naperville, IL (US)

(21) Appl. No.: 18/086,287

(22) Filed: Dec. 21, 2022

Related U.S. Application Data
(60) Provisional application No. 63/292,053, filed on Dec. 21, 2021.

(51) Int. Cl. H01M 10/0565; H01M 10/0525; H01M 4/48; H01M 4/58; H01M 4/62

(52) U.S. Cl. CPC H01M 10/0565; H01M 10/0525; H01M 4/483; H01M 4/5825; H01M 4/625; H01M 2300/0091; H01M 2220/20

(57) ABSTRACT

Methods of making an electrolyte for a solid-state battery can include dissolving a lithiated perfluorosulfonic acid in a solvent to form a mixture, stirring the mixture using shear mixing, and heating the mixture to form an electrolyte gel. Methods of making a cathode electrode for a solid-state battery include forming an electrode composition including active materials, stirring the mixture using sheer mixing to reduce particle size and to form an ink, coating the ink on aluminum foil using one of doctor blade, micro gravure, and slot-die, and drying. The electrolyte is applied as an overlayer on the electrode.

### CROSS-REFERENCE TO RELATED APPLICATIONS

This application claims the benefit of U.S. Provisional Application No. 63/292,053, filed on Dec. 21, 2021. The entire disclosure of the above application is hereby incorporated herein by reference.

### FIELD

The present technology includes processes and articles of manufacture that relate to solid-state lithium-ion batteries, including a method of making and processing a catholyte and an anolyte for solid state batteries.

### INTRODUCTION

This section provides background information related to the present disclosure which is not necessarily prior art.

All solid-state batteries are gaining significant attention in lithium-ion battery development due to several advantages, including consistent operation, high energy density, and faster charging properties. However, certain challenges remain to be overcome, especially with respect to solid-state electrolytes, to improve conductivity and suppress formation of lithium dendrites. Two main approaches are being employed to develop solid electrolytes, the first being the use inorganic ceramic solid electrolytes and the second being use of a solid polymer electrolyte, where both approaches have their own advantages and disadvantages.

Advantages of all solid-state lithium-ion batteries include high energy density and safety. However, while expectations for solid-state batteries are high, there are still issues related to materials, processing, and engineering to overcome. Certain types and applications of batteries can require dimensions and configurations that can be difficult to process, handle, and manipulate during manufacture, which can also present issues during use of the assembled battery. Batteries can be subjected to environments that can experience particular shocks related to physical forces as well as varying temperatures, where it may be optimal to design a battery that can provide a predetermined performance throughout a wide range of operating conditions. Durability and stability of electrode and electrolyte components of the battery are hence important considerations in manufacture and performance of the assembled battery.

In an all-solid state battery, the interfaces between particular layers can play a significant role. Examples of such interfaces include the interface between an electrode and an electrolyte, the interface between an electrode and a current collector, and the interface between materials within the electrode itself. Minimizing the electrode and the electrolyte interface can reduce lithium-ion transport and resistance. The restricted mobility of lithium ion in the solid-state poses significant challenges to increasing the cathode loading. Currently, cathode loading is kept low to minimize the transport issue. However, to increase the energy density, more cathode loading is needed without utilization tradeoff. This problem can be addressed in solid-state batteries by using low loaded cathode electrodes. However, to increase the energy density of solid-state batteries, the cathode electrode loading, and thickness thereof, needs to be substantially increased without a significant trade-off in utilization of active materials. Additionally, optimized particle size distribution of active materials in the electrode is needed to achieve good performance, good electrolyte utilization, and cycling stability in solid-state electrolyte batteries.

Accordingly, there is a need to increase lithium-ion transport and conductivity through a way of making and processing the catholyte, which in turn can improve the rate capacity within a solid-state battery. Optimizing the respective interfaces in cathode electrode design and processing should provide improved performance with respect to speed and scale of battery manufacture, and increase operational integrity of the battery.

### SUMMARY

In concordance with the instant disclosure, ways to increase lithium-ion transport and conductivity in making and processing the catholyte, which in turn can improve the rate capacity within a solid-state battery, are surprisingly discovered.

Ways of making anion free gel electrolytes, cathode electrodes, and batteries are provided herein. In certain embodiments, methods of making a solid-state electrode and electrolyte are provided. These methods include forming an electrode layer using an electrode composition, where the electrode composition includes a cathode active material, a lithiated ionomer, and an electrically conductive additive. An electrolyte composition is applied to the electrode layer to form an electrolyte overlayer. The electrolyte composition can be formed by combining a lithiated perfluorosulfonic acid and a solvent to form an electrolyte mixture. The electrolyte mixture is mixed and incubated for 30 minutes to 60 minutes. In this way, the electrode layer, and the electrolyte overlayer form an electrode-electrolyte composite. The electrode-electrolyte composite can exhibit improved durability and stability during manufacture and operation of a solid-state lithium-ion battery employing the composite.

In certain embodiments, the cathode active material includes one of a metal oxide and a metal phosphate. The cathode active material can include the metal oxide. The metal oxide can include a member selected from a group consisting of cobalt oxide, iron oxide, manganese oxide, and nickel oxide. The cathode active material can include the metal phosphate. The metal phosphate can include a member selected from a group consisting of cobalt phosphate, iron phosphate, manganese phosphate, and nickel phosphate.

The lithiated ionomer can include a lithiated perfluorosulfonic acid. In certain embodiments, the lithiated perfluorosulfonic acid can include a member selected from a group consisting of: trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid; and combinations thereof.

The electrically conductive additive can include a member selected from a group consisting of carbon, carbon black, carbon microfibers, carbon nanofibers, carbon nanotubes, graphite nanofibers, and graphene. In certain embodiments, the electrode composition can have a ratio of (the cathode active material):(the lithiated ionomer):(the electrically conductive additive) of (60-85):(10-20):(5-20). The method of claim 1, wherein the electrode composition can be processed to form a predetermined particle size prior to forming the electrode layer using the electrode composition.

The electrolyte mixture can be incubated at room temperature. In particular, the electrolyte mixture can be incubated at a temperature from 50° C. to 70° C. The lithiated perfluorosulfonic acid of the electrolyte composition can include a member selected from a group consisting of: trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid, and combinations thereof. The solvent of the electrolyte composition can include a member selected from a group consisting of: polycarbonate, N-methyl-2-pyrrolidone (NMP), polycarbonate/ethyl cellulose mixture, polycarbonate/NMP mixture, polycarbonate/diethyl carbonate mixture, and combinations thereof. The solvent of the electrolyte composition can comprise a dielectric constant between 35 and 200 with a moderate to high electrochemical potential window. In certain embodiments, a swelled lithiated perfluorosulfonic acid garnet can be added as a composite electrolyte. The lithiated perfluorosulfonic acid can comprise between 5% and 25% of the electrolyte mixture.

In certain embodiments, a solid-state electrode and electrolyte can be made with the electrode-electrolyte composite. A solid-state lithium-ion battery can comprise a solid-state electrode and electrolyte made according to the method as described above. A vehicle can comprise a solid-state lithium-ion battery including a solid-state electrode and electrolyte made according to the above described method.

Various solid-state electrode and electrolytes can be made according to the present technology. Such electrode-electrolyte composites can be incorporated into all solid-state lithium-ion batteries. Likewise, various batteries, including multicell batteries, can be manufactured using one or more of the electrode-electrolyte composites. Certain applications include vehicles using a solid-state lithium ion battery that incorporates one or more electrode-electrolyte composites made in accordance with the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic flowchart of a method of making a solid-state electrode and electrolyte for a solid-state lithium-ion battery by layering, in accordance with the present technology; and

FIG. 2 is a schematic cross-sectional design of an embodiment of a solid-state lithium-ion battery that includes an electrode and electrolyte overlayer formed in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to catholyte and anolyte design and processing within a solid-state lithium-ion battery. Methods and articles of manufacture formed using the subject methods provide certain benefits and advantages in all solid-state batteries, including batteries used for various portable and mobility applications such as vehicles. Several issues with respect to solid-state batteries are addressed by the present technology, including the lithium-ion transport and conductivity within a solid-state battery, while minimizing a trade off in performance. Increasing the lithium-ion transport and conductivity by a way of making and processing the catholyte, can improve the rate capacity and can optimize performance through enhanced lithium and electrical pathways.

Methods of making a solid-state electrode and electrolyte are provided where an electrolyte composition is applied to an electrode layer to form an electrolyte overlayer. The electrolyte composition can be formed by combining a lithiated ionomer (e.g., a lithiated perfluorosulfonic acid) and a solvent to form an electrolyte mixture. The electrolyte mixture can be mixed and incubated for 30 minutes to 60 minutes. Application of the electrolyte composition to form the electrolyte overlayer in this manner can optimize the interface between the electrode and the electrolyte overlayer. In this way, the electrode layer and the electrolyte overlayer form an electrode-electrolyte composite for use in a solid-state lithium-ion battery. The electrode-electrolyte composite can exhibit improved durability and stability during manufacture and operation of a solid-state lithium-ion battery employing the composite.

In certain embodiments, the cathode active material includes one of a metal oxide and a metal phosphate. Where the cathode active material includes the metal oxide, the metal oxide can include a member selected from a group consisting of cobalt oxide, iron oxide, manganese oxide, and nickel oxide. Where the cathode active material includes the metal phosphate, the metal phosphate can include a member selected from a group consisting of cobalt phosphate, iron phosphate, manganese phosphate, and nickel phosphate.

The lithiated ionomer can include a lithiated perfluorosulfonic acid. In certain embodiments, the lithiated perfluorosulfonic acid can include a member selected from a group consisting of: trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid; and combinations thereof.

The electrically conductive additive can include the following aspects. Examples of the electrically conductive additive include carbon, carbon microfibers, carbon nanofibers, carbon nanotubes, graphite nanofibers, and graphene. Mixtures of various electrically conductive additives can be used. In certain embodiments, the electrically conductive additive can include Super P™, a structured carbon black powder with a moderate surface area, available from Imerys S. A. (Paris, France).

The solvent of the electrolyte composition can include a member selected from a group consisting of: polycarbonate, N-methyl-2-pyrrolidone (NMP), polycarbonate/ethyl cellulose mixture, polycarbonate/NMP mixture, polycarbonate/diethyl carbonate mixture, and combinations thereof. The solvent of the electrolyte composition can comprise a dielectric constant between 35 and 200 with a moderate to high electrochemical potential window.

In certain embodiments, a swelled lithiated perfluorosulfonic acid garnet can be added as a composite electrolyte. The lithiated perfluorosulfonic acid garnet reinforced electrolyte can be attached to the overlayer gel electrolyte and lithium foil as an anode. The lithiated perfluorosulfonic acid can comprise between 5% and 25% of the electrolyte mixture.

The electrolyte mixture can be incubated at a predetermined temperature. In certain embodiments, the electrolyte mixture can be incubated at room temperature. Other embodiments include where the electrolyte mixture can be incubated at a temperature from 50° C. to 70° C.

A method of making a solid-state electrode and electrolyte is provided that includes forming an electrode layer using an electrode composition, where the electrode composition includes a cathode active material, a lithiated ionomer, and an electrically conductive additive. An electrolyte composition is applied directly to the electrode layer to form a first electrolyte layer, where the electrolyte composition includes a lithiated perfluorosulfonic acid and a first solvent.

The electrode composition can include the following aspects. The electrode composition can have a ratio of (the cathode active material):(the lithiated ionomer):(the electrically conductive additive) of (60-85):(10-20):(5-20). Certain embodiments include where the ratio of (the cathode active material):(the lithiated ionomer):(the electrically conductive additive) includes 60:20:20, 70:10:20, 70:20:10, 80:10:10, and 85:10:5. The electrode composition can be processed to form a predetermined particle size prior to forming the electrode layer using the electrode composition. Embodiments include where the predetermined particle size can be from 10 nanometers to less than 1 micrometer. Various processes can be employed to form the predetermined particle size, including use of a high shear rotary mixer, a ball mill, various overhead mixers, high pressure mixers, planetary ball mixers, and the like.

The lithiated perfluorosulfonic acid of the electrolyte composition can include the following aspects. The lithiated perfluorosulfonic acid can have an equivalent weight (EW) of 300 to 1100. The lithiated perfluorosulfonic acid can include one or more of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The solvent of the electrolyte composition can include the following aspects. The solvent can include one or more various organic solvents, including various alcohols, as well as various aprotic solvents, including various amines and cyclic amines. Particular examples of solvents include polycarbonate, N-methyl-2-pyrrolidone (NMP), polycarbonate/ethyl cellulose mixture, polycarbonate/NMP mixture, polycarbonate/diethyl carbonate mixture and/or water.

In certain embodiments, the electrolyte composition used to form the electrolyte layers can include a ceramic oxide. The ceramic oxide can include various garnet type oxides. Particular examples of the ceramic oxide include one or more of lithium lanthanum zirconium oxide (LLZO), metal (M) doped lithium lanthanum zirconium oxide (LLZMO), lithium lanthanum titanium oxide (LLTO), metal (M) doped lithium lanthanum titanium oxide (LLTMO), and combinations thereof, where the metal (M) can be one or more of aluminum, niobium, and tantalum.

The electrolyte composition can be processed to form a predetermined particle size prior to applying the electrolyte composition directly to the electrode layer to form the first electrolyte layer. For example, where the electrolyte composition used to form the electrolyte layers includes a ceramic oxide, the electrolyte composition can be processed so that the ceramic oxide, as well as any other components of the electrolyte composition have a predetermined particle size. The particle size can include a window or range of particle sizes having a lower limit and an upper limit. The particle size can also include where a majority of the particles have a predetermined particle size. Examples include where the predetermined particle size is from 10 nanometers to less than 1 micrometer.

In certain embodiments, the electrolyte composition can include an anion-free gel electrolyte. The anion-free gel electrolyte can be based upon a perfluorosulfonic acid, where substantially all of the anionic sites of the perfluorosulfonic acid are associated with a species of cation, such as a lithium ion. The anion-free gel electrolyte can be formed by lithiating a perfluorosulfonic acid or a mixture of perfluorosulfonic acids, having an equivalent weight range from 350 to 1100, in a single solvent or a solvent blend including one or more of polycarbonate, N-methyl-2-pyrrolidone (NMP), polycarbonate/ethyl cellulose mixture, polycarbonate/NMP mixture, polycarbonate/diethyl carbonate mixture, and water. The solvent or solvent blend can have a dielectric constant from 35 to 200 and exhibit a moderate to high electrochemical potential window. Lithiating the perfluorosulfonic acid can include using an equimolar amount of lithium ion to sulfonic acid groups, or where the amount of lithium ion is in excess of the sulfonic acid groups. The lithiated-perfluorosulfonic acid in the anion-free gel electrolyte can be in a range from 5 wt % to 25 wt %. The lithiated-perfluorosulfonic acid can be added to the solvent mixture over a predetermined period of time while mixing under different rates of shear at room temperature. Application of a shear force can be through use of a high shear rotary mixer, a ball mill, various overhead mixers, high pressure mixers, planetary ball mixers, and the like. The anion-free gel electrolyte can also be adjusted to a more gel-like consistency by mixing under different rates of shear and heating from 50° C. to 70° C. for 30 minutes to 1 hour. The anion-free gel electrolyte can be prepared in an inert atmosphere, such as under argon or nitrogen, to prevent undesired oxidation and to maintain the anion-free state of the gel electrolyte. Viscosity of the anion-free gel electrolyte can be tailored to particular coating processes for application as the electrolyte overlayer on the electrode layer; e.g., using a doctor blade, micro gravure roller, slot die, etc.

Applying the electrolyte composition directly to the electrode layer to form the first electrolyte layer can include the following aspects. Various apparatus and techniques can be selected based upon the nature of the electrode layer, considering dimensions as well as workflow. The nature of the desired first electrolyte layer can also be considered in applying the electrolyte composition. Application methodologies can include using a doctor blade, a micro gravure roller, as well as a slot die, for example.

The electrode-electrolyte composite formed by the present technology can be subject to further processing steps. In certain embodiments, a swelled lithiated perfluorosulfonic-garnet may be added as the composite electrolyte The lithiated perfluorosulfonic-garnet reinforced electrolyte can be attached to the overlayer gel electrolyte and Lithium foil as an anode. The gel electrolyte can also be added to the anode. In certain embodiments, an anode layer can be disposed adjacent the electrode-electrolyte composite, where the anode layer includes a first metal layer. The first metal layer can include lithium.

Various articles of manufacture can be produced in accordance with the present technology. The solid-state electrode and electrolyte made according to the present methods can be provided, including the resulting electrode-electrolyte composite. Various solid-state lithium-ion batteries can incorporate the solid-state electrode and electrolyte made according to the present methods. Likewise, various articles and systems employing solid-state lithium-ion batteries can use the present technology. A particular example includes a vehicle that includes a solid-state lithium-ion battery incorporating the solid-state electrode and electrolyte made as described herein.

### Examples

Example embodiments of the present technology are provided with reference to the figures enclosed herewith.

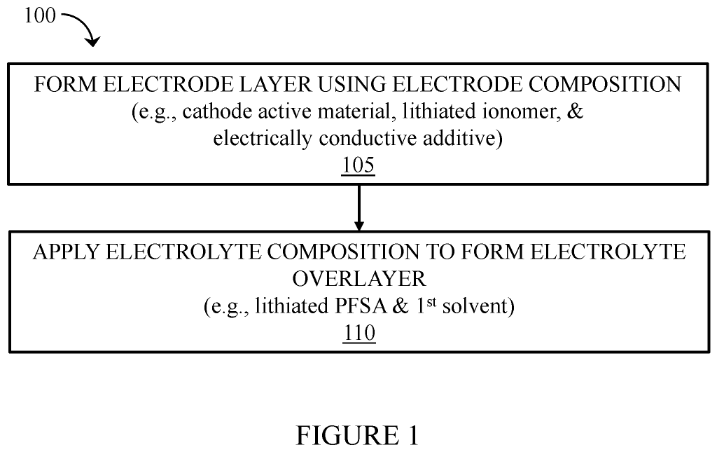

With reference to FIG. 1, an embodiment of a method of making a solid-state electrode and electrolyte for a solid-state lithium-ion battery by layering is shown at 100. At 105, an electrode layer can be formed using an electrode composition, where the electrode composition can include a cathode active material, a lithiated ionomer, and an electrically conductive additive. At 110, an electrolyte composition is applied to the electrode layer to form an electrolyte overlayer thereon. The electrolyte composition can be formed by combining a lithiated perfluorosulfonic acid and a solvent. The electrolyte composition can be mixed and incubated for 30 minutes to 60 minutes. In this way, the electrode layer and the electrolyte overlayer can form an electrode-electrolyte composite.

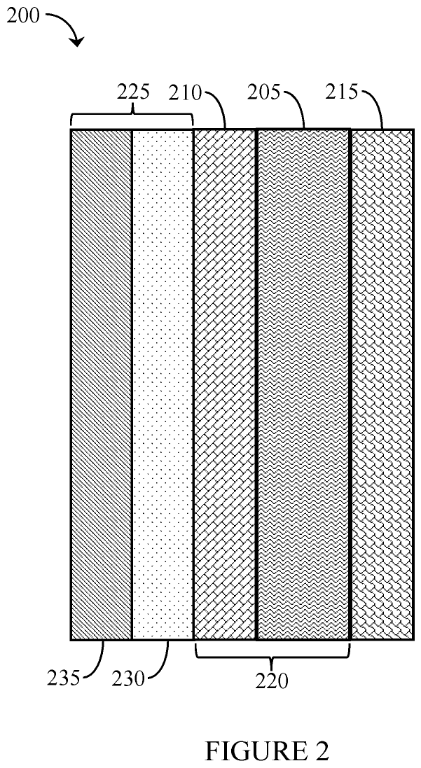

With reference to FIG. 2, a schematic cross-sectional design of an embodiment of a solid-state electrode and electrolyte for a solid-state lithium-ion battery is shown at 200. An electrode layer 205 is formed from an electrode composition including a cathode active material, a lithiated ionomer, and an electrically conductive additive. An electrolyte overlayer 210 is formed by applying an electrolyte composition to the electrode layer 205, the electrolyte composition can be in the form of a gel or a gel like material, where the electrolyte composition includes a lithiated perfluorosulfonic acid and a first solvent. The electrode layer 205 and the electrolyte overlayer form an electrode-electrolyte composite 220. A ceramic oxide can be added to the electrolyte composition. An anode layer 225 can be disposed adjacent the electrolyte overlayer 210 of the electrode-electrolyte composite 220. The anode layer 225 can include a lithium layer 230 coated onto a copper layer 235. A metal layer 215 can be disposed adjacent the electrode layer 205. The metal layer 215 can include an aluminum layer, where the metal layer 215 can therefore function as an aluminum current collector.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a solid-state electrode and electrolyte, comprising:
forming an electrode layer using an electrode composition, the electrode composition including a cathode active material, a lithiated ionomer, and an electrically conductive additive; and
applying an electrolyte composition to the electrode layer to form an electrolyte overlayer, the electrolyte composition formed by mixing a lithiated perfluorosulfonic acid and a solvent;
wherein the electrode layer and the electrolyte overlayer form an electrode-electrolyte composite.

2. The method of claim 1, wherein the cathode active material includes one of a metal oxide and a metal phosphate.

3. The method of claim 2, wherein the cathode active material includes the metal oxide, and the metal oxide includes a member selected from a group consisting of cobalt oxide, iron oxide, manganese oxide, and nickel oxide.

4. The method of claim 2, wherein the cathode active material includes the metal phosphate, and the metal phosphate includes a member selected from a group consisting of cobalt phosphate, iron phosphate, manganese phosphate, and nickel phosphate.

5. The method of claim 1, wherein the lithiated ionomer includes a lithiated perfluorosulfonic acid.

6. The method of claim 5, wherein the lithiated perfluorosulfonic acid includes a member selected from a group consisting of: trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid; and combinations thereof.

7. The method of claim 1, wherein the electrically conductive additive includes a member selected from a group consisting of carbon, carbon black, carbon microfibers, carbon nanofibers, carbon nanotubes, graphite nanofibers, and graphene.

8. The method of claim 1, wherein the electrode composition has a ratio of (the cathode active material):(the lithiated ionomer):(the electrically conductive additive) of (60-85):(10-20):(5-20).

9. The method of claim 1, wherein the electrolyte composition further comprises a ceramic oxide.

10. The method of claim 9, wherein the electrolyte composition is processed to form a predetermined particle size prior to applying the electrolyte composition to the electrode layer to form the electrolyte overlayer.

11. The method of claim 1, wherein mixing the lithiated perfluorosulfonic acid and the solvent includes applying a shear force for a predetermined amount of time and at a predetermined temperature to form a gel.

12. The method of claim 11, wherein the predetermined time is from 30 minutes to 60 minutes and the predetermined temperature is from 50° C. to 70° C.

13. The method of claim 1, wherein the lithiated perfluorosulfonic acid of the electrolyte composition includes a member selected from a group consisting of: trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid, and combinations thereof.

14. The method of claim 1, wherein the solvent of the electrolyte composition includes a member selected from a group consisting of: polycarbonate, N-methyl-2-pyrrolidone (NMP), polycarbonate/ethyl cellulose mixture, polycarbonate/NMP mixture, polycarbonate/diethyl carbonate mixture, and combinations thereof.

15. The method of claim 14, wherein the solvent of the electrolyte composition comprises a dielectric constant between 35 and 200.

16. The method of claim 1, wherein the lithiated perfluorosulfonic acid comprises between 5% and 25% of the electrolyte mixture.

17. The method of claim 1, wherein the electrolyte composition is in the form of one of a gel and a gel-like material.

18. A solid-state electrode and electrolyte made according to the method of claim 1.

19. A solid-state lithium-ion battery comprising a solid-state electrode and electrolyte made according to the method of claim 1.

20. A vehicle comprising a solid-state lithium-ion battery including a solid-state electrode and electrolyte made according to the method of claim 1.
